(19) United States
(12) Patent Application Publication
(10) Pub. No.: US 2007/0084065 A1
(43) Pub. Date: Apr. 19, 2007

(54) Slit pick and hold triple function graphic arts safety blade

(76) Inventors: Terry Lee Wagenknecht, Rockford, IL (US); Samuel James Wagenknecht, Rockford, IL (US); Charles Maxwell Wagenknecht, Rockford, IL (US)

Correspondence Address: TERRY LEE WAGENKNECHT, 6693 HEATHER LANE, ROCKFORD, IL, 61114, US

(21) Appl. No.: 11/252,119

(22) Filed: Oct. 17, 2005

(51) Int. Cl. B26B 9/02

(52) U.S. Cl. 30/357

(57) ABSTRACT

A triple function slitting, picking, and holding safety blade for use in the graphic arts trade, for slitting through, picking up, and holding portions of computer cut vinyl adhesive material. A slight rotation of a user's blade holding tool changes a blade's function from slitting to picking to hold-down modes with increased user safety with its restricted blade penetration and with fewer carpal tunnel stress motions required in its use. A notch within a cutting edge of and near to a cutting edge tip of a generally triangular shaped cutting blade end exposes a new cutting edge tip, with an area between said tip locations being curvedly and or angularly bent to produce a pointed picking hook with an exterior blunt surface for serving as a material hold down tool, and wherein said bend further exposes said new cutting edge tip with sufficient clearance to slit a material's planar surface.

### CROSS-REFERENCE TO RELATED APPLICATIONS

| | | | |
|---|---|---|---|
| 2,827,697 | March 1958 | Woodell | 30/293 |
| 2847758 | September 1958 | Kozan | 30/164 |
| 2885780 | May 1959 | Campbell | 30/164 |
| 3080653 | March 1963 | Dolin | 30/329 |
| 3162475 | December 1964 | Van Allen | 30/322 |
| 4316326 | February 1982 | Yeaton | 30/366 |
| 4,404,749 | September 1983 | Emerson | 30/164.9 |
| 5,893,865 | April 1999 | Swindle | 606/185 |
| 6,058,611 | May 2000 | Rickard | 30/349 |

### STATEMENT REGARDING FEDERALLY SPONSORED RESEARCH OR DEVELOPMENT

Not applicable.

### REFERENCE TO SEQUENCE LISTING

Not applicable.

### BACKGROUND

1. Field of the Invention;

This invention relates to tool held cutting blades, awl type picking devices, and round blunt ended styluses, and particularly to those intended for use within the graphic arts trade, and especially to those which have a plurality of functions including cutting, picking, and holding graphic arts materials, and also especially those which include a slight rotational twist of a user's hand held blade holding tool for quickly changing between said functions.

2. Description of Prior Art;

Previous knife blades made for fine detailed hand cutting within the graphic arts trade were made with a very long and sharp point. Most blades are formed with a triangular shaped end, and with a cutting edge extending completely to a very end of a blade's apex end point tip. A long and tapered point of previous blade versions can pierce a user's skin with an ability to easily penetrate up to the full depth of a blade's long length.

A process of removing unwanted vinyl from its carrier backing is normally described as weeding. A standard picking awl which is used to pick up and pull out unwanted areas within vinyl cut adhesives can also easily penetrate a user's body up to the full depth of it's shaft. A picking awl with a curved hook near its end point is safer in use, but slower in production. After cutting around an area of vinyl lettering to be removed, a user must lay down a cutting knife, find and pick up the curved end point awl, and then orient its point for picking out unwanted material. When finished with an area of material weeding, a user once again finds a cutting knife, picks it up, and orients its blade for cutting, or as in this purpose, slitting the vinyl material. In a busy shop, this process is repeated from several hundred and up to several thousand times a day with a chance each time of accidentally grabbing the wrong pointed end in the wrong way for a stabbing surprise.

A blunt and round ended hand held stylus is normally used for retaining small wanted areas of vinyl to its carrier sheet while weeding away the background, and also to prevent damage or piercing of these same wanted areas. One tool or tool-held blade which could cut or slit and or pick up and or retain different parts of a vinyl material while remaining in a user's hand in a safe and vinyl protecting way, was not found. None were found which enabled a switching from one mode to another with a slight rotational twist of a blade's holding tool within a user's hand. Other than something similar to a blunted end point stylus, none were found that ever seemed quite safe enough.

Today's work environment of home based vinyl shops endanger small children and their visitors by exposing them to these dangerous cutting blades and picking styluses. The workplace location has rapidly changed from commercial storefronts to home based operations, and yet the working tools for this industry have not yet changed to meet more stringent and needed safety requirements.

Also, none were found which were color coded on one or more sides for a user's instant recognition of its cutting or picking orientation. Not all users have perfect vision, or always have perfect lighting when weeding vinyl material, and so have to pause each time for properly aligning a cutting or hooking tool. Color coding can instantly tell a user how their tool is oriented, yet none were found.

Some tool holders do have various shaped cutting blades or picks which are compactly retained within their body; yet require unscrewing the tool holder itself, then unscrewing whichever tool is in use, and then screwing in a wanted tool cutting blade, or picker, or blunt end stylus. Many variations of tool blades and holders and clever ways of storing the tools within their holders soon lose their appeal when in an actual fast pace work situation. In the particular job of weeding vinyl material, and especially in today's new home work environment, speed and safety are crucial.

Today's fast pace workplace requires much more speed and safety as a user switches from cutting blades to hold-down styluses to picks; and certainly much more speed and safety than what was previously provided by any prior art.

### SUMMARY

A triple function slitting, picking, and holding safety blade for use in the graphic arts trade, for slitting through, picking up, and holding down of areas of computer cut vinyl adhesive material. A slight rotation of a user's blade holding tool changes a blade's function from slitting to picking to hold-down modes with increased user safety from its restricted blade penetration and fewer carpal tunnel stress motions.

### OBJECTS AND ADVANTAGES

This invention of a slit, pick and hold safety blade may be newly formed from hardened metal, or newly formed prior to its hardening, or from a previously made metal blade, or a mold injected polymer plastic.

Accordingly, besides any objects and advantages previously described, more objects and advantages of this present invention are;

(a) to provide a cutting blade end area wherein a multiple choice of functions are accessible as a user slightly rotates said blade's holding tool;

(b) to provide said choices of cutting or slitting, and or hooking or picking, and or holding of a planar vinyl adhesive material to and or from its carrier sheet;

(c) and to provide a safer cutting blade wherein a blade's depth of penetration is restricted by a curved and or angularly curved bend of its picking hook;

(d) to provide a blade end area which can be utilized by and merged with a manufacturers' choice of blade shank end shape and tool holder retaining designs;

(e) to provide a multi use blade wherein instant recognition of its orientation is seen through coloring added to at least one planar side of its blade edge;

(f) to provide a barb-less hook for easy removal of unwanted vinyl material;

(g) to provide a blade wherein a one directional pulling motion achieves either function of cutting or picking up of material with less stress upon a carpal tunnel sensitive and overly used hand;

(h) to provide a multi purpose blade for faster work production by eliminating a need for finding, picking up, and orienting a next tool for cutting and or picking and or holding actions;

(i) to provide a cutting pick safety blade for holding down wanted material without damage to said material with said hook's bluntly shaped safety bend.

### BRIEF DESCRIPTION OF THE DRAWINGS—Drawings 1 Through 10—

In the drawings, dotted lines represent a portion of a blade shank of any shape 20, which is unrelated to this invention which particularly relates to a blade's end area 30 and with dotted lines shown for more complete and understandable drawings.

FIG. 1 is a side view of a preferred embodiment showing a notch within a blade's cutting edge, and a blade's end area which is curvedly and angularly bent to form a pointed hook shape.

FIG. 2 is a side view of a preferred embodiment showing said notch, and prior to a forming of said hook shape.

FIG. 3 is a side and slightly rotated view of FIG. 1's preferred embodiment, and where a cutting edge is slightly rotated toward a person viewing the drawing.

FIG. 4 is a side and 90 degree rotated view of FIG. 1's preferred embodiment, and where said edge is rotated completely toward a person viewing the drawing.

FIG. 5 is a side view of said preferred embodiment, and with its longitudinal elongate direction and its blade cutting edge in position for material cutting.

FIG. 6 is a side view of a blade as in FIG. 5, but after a blade and it's holder are slightly rotated to a hook function position, and with said hook shown as it is has pierced and is picking up unwanted vinyl material, and with holder not shown.

FIG. 7 is a side view as in FIG. 5, but with a curved hook shape shown without the previous angled bend, and where its cutting edge tip is still accessible to a material's surface for cutting, but with less tolerance in its tool held angled position.

FIG. 8 is a side view as in FIG. 5, showing a curved and angled bend, wherein is a more tolerant tool holding position than FIG. 7, and which is due to said angle.

FIG. 9 is a side view showing said hook's blunt, rounded, and angled bend holding down wanted material as a user is pulling up unwanted vinyl background, and with user and blade holding tool not shown.

FIG. 10 is a side view showing an alternative embodiment with double edge cutting blade surfaces with a notch in place, and prior to a hook forming angled bend.

### REFERENCE NUMERALS IN DRAWINGS

20—blade shank of any shape
30 —a blade's end area; and of the specific area of which this application applies to
40 —blade end area's elongate cutting edge
50 —blade end area's non-cutting flat edge
60 —a blade end's apex point; and also described as a first, or original cutting edge tip
70 —exposed cutting edge tip; and also described as a second, or new cutting edge tip
80 —notched area
90 —rounded and or angled safety bend of hook shape
99 —planar surface of material to be cut or slit

### Preferred Embodiment

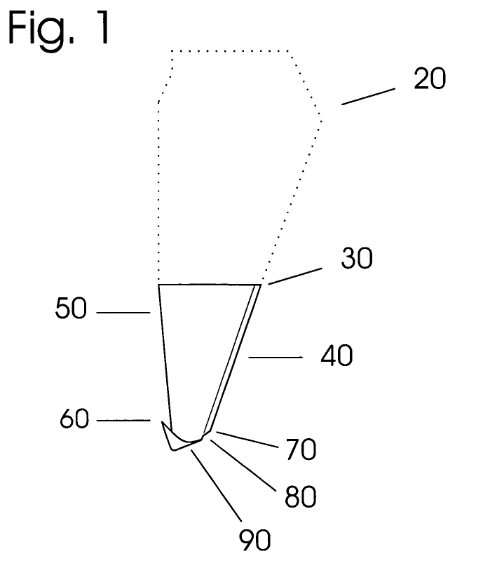

A preferred embodiment as in FIG. 1 comprises;

A slitting, picking and holding safety blade which is newly formed from hardened metal, or newly formed prior to its hardening, or from a previously made blade, or a mold injected polymer plastic, and wherein its shape comprises; a planar and triangular shape blade end area 30 as part of a larger planar and triangular shape, and with it's blade shank in any shape 20. Said shape 20 may vary according to its holder's dimensional requirements. One elongate cutting edge of a blade end area 40 contains a notch 80, and is where a bending location begins of a curved hook shape 90. Said bending ends just near an original cutting edge tip 60 of said triangular shape blade end area 30. Said bending within this particular embodiment is approximately and curvedly bent from as shown from said blade's planar and notched surface. An exact degree of bend is made accordingly to a manufacturing user's preference of an angle in which a tool held blade is held within a user's hand. Said bending may also be directionally angled slightly toward said blade's non-cutting flat edge surface 50, wherein said original cutting edge tip 60 is more exposed as said hook's awl-like picking point. A new and second cutting edge tip 70 is exposed as a part of said notch 80, wherein said angled bending further exposes said new cutting edge tip 70 for its clearance to abut a planar surface of a material to be cut or slit. This preferred embodiment contains only one initial elongate cutting edge surface before forming said notch, or forming said hook forming angled bend. A blade's thickness may vary according to its manufacturing user's chosen holder's dimensional requirements. Previous descriptions of this preferred embodiment of a slit, pick, and hold triple function graphic arts safety blade describe a blade's end area 30, and as it would be if formed from a previously made blade, and are not intended to restrict the invention to any particular manufacturing process or material, or to its restriction of any particular or single edged cutting blade surface.

### Operation

A cutting pick safety blade may be newly formed from hardened metal, or newly formed prior to its hardening, or from a previously made blade, or polymer plastic.

The following description refers to forming a cutting pick safety blade from a previously made blade. Said previously made blade would preferably be a thin and planar steel blade with a generally triangular shape, wherein it's blade shank of any shape 20 would be interchangeable with a chosen blade holder tool. Said holder tools are generally pencil like in shape and size.

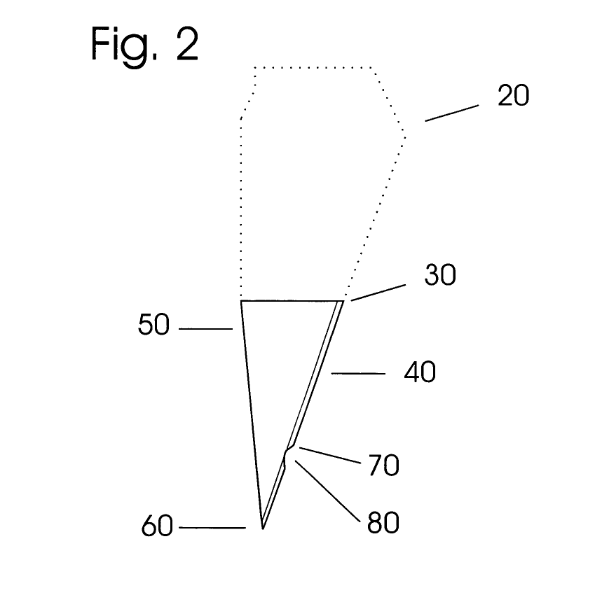

A manufacturing user would cut, file or grind a notch 80, FIG. 2, within a blade end area's 30 elongate cutting edge 40 and located very near to said edge's original cutting edge tip 60. Any detailed sharpening or honing of said notch's 80 new cutting edge tip 70 may depend on which said previous method is used to create said notch 80, and depending on said user's preference in its degree of sharpness. Said new cutting edge tip 70 within the preferred embodiment of FIG. 1, is purposed to cut or slit a planar and thin layer of vinyl material 99, FIG. 6.

Said notch 80 is located approximately ⅛ to 3/16 inch in and up to ½ inch in from said blade end area's 30 original cutting edge tip 60, and within said blade end area's elongate cutting edge surface 40. An exact said locational distance finally depends on an original size and length of said previously made blade.

Said new cutting edge tip 70 is accessible to cut or slit said planar and thin layer of vinyl material 99, FIG. 6 surface after a bending of an area between said notch 80 and said original cutting edge tip 60. Said bend's curvature begins within said notch, and ends near to and before reaching said original cutting edge tip 60. Shown in FIG. 2, is the inaccessibility of said new cutting edge tip's 70 clearance to abut and cut or slit a planar material's surface before said bend is formed.

Said bending produces a rounded bend hook shape 90. A tapered end area of said triangular shape blade end area 30 now curvedly rolls back and away from said new cutting edge tip 70 to provide sufficient clearance for said tip 70 to abut and slit a material's planar surface 99. Said round bend of said hook shape 90 is bent dimensionally and accordingly to a manufacturing user's preference for accessibility to a material's surface for both cutting and picking functions. Said bend is quite functional, yet may limit a user in an angle in which a tool held blade is retained within their hand. Said tool blade holder may be more closely parallel with a material's planar surface than desired with some users. A user's index finger would normally be parallel with said holder's elongate direction, and approximately located vertically above and near said held blade. Some users prefer this position of holding said tool held blade, while others prefer a more relaxed position, such as a hand held pen or pencil position when writing.

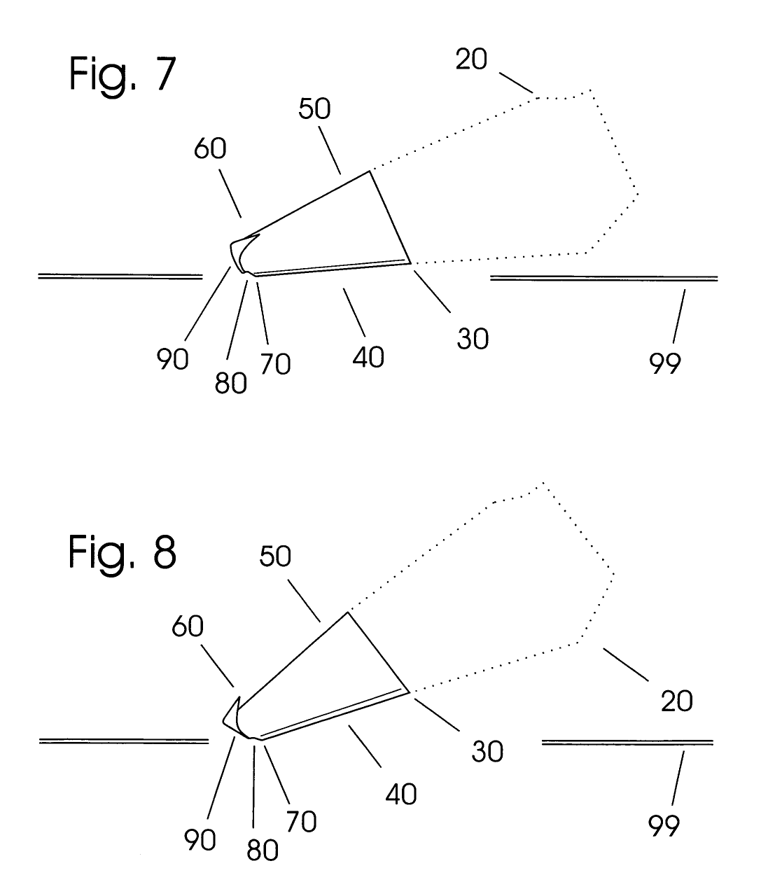

To achieve this more tolerant angle of a hand held blade holding tool, a manufacturing user may angle said bend of said hook shape 90 slightly towards a a blade end area's non-cutting flat edge 50. Said angled bend now further exposes said new cutting edge tip 70 to permit a greater degree of angle in which said blade's tool holder is held. Note this difference in FIGS. 7 and 8.

Said original cutting edge tip 60 is now a pricking point of said rounded bend hook shape 90, and wherein said angled bend also now further exposes said original cutting edge tip 60 further beyond said non-cutting edge 50, for easier accessibility to said material's surface 99 to be picked away. Note tip 60 in FIG. 1.

A manufacturing user may tweak any degrees of said bends, angles, or location of said notch to target a chosen market of users, and also accordingly to a size of blade chosen to accommodate their chosen blade tool holder, and or accordingly when a double edge cutting blade is chosen as an alternative embodiment FIG. 10.

Previous descriptions in the making of a slit, pick, and hold triple function graphic arts safety blade describe how to easily make said safety blade from a previously made blade, and are not intended to restrict the invention to any particular manufacturing process or material, or single or double edge cutting blade.

In using a slit pick and hold triple function graphic arts safety blade, a user or manufacturer may identify one or more planar sides with an added coloring for instant recognition of said blade's orientation or function.

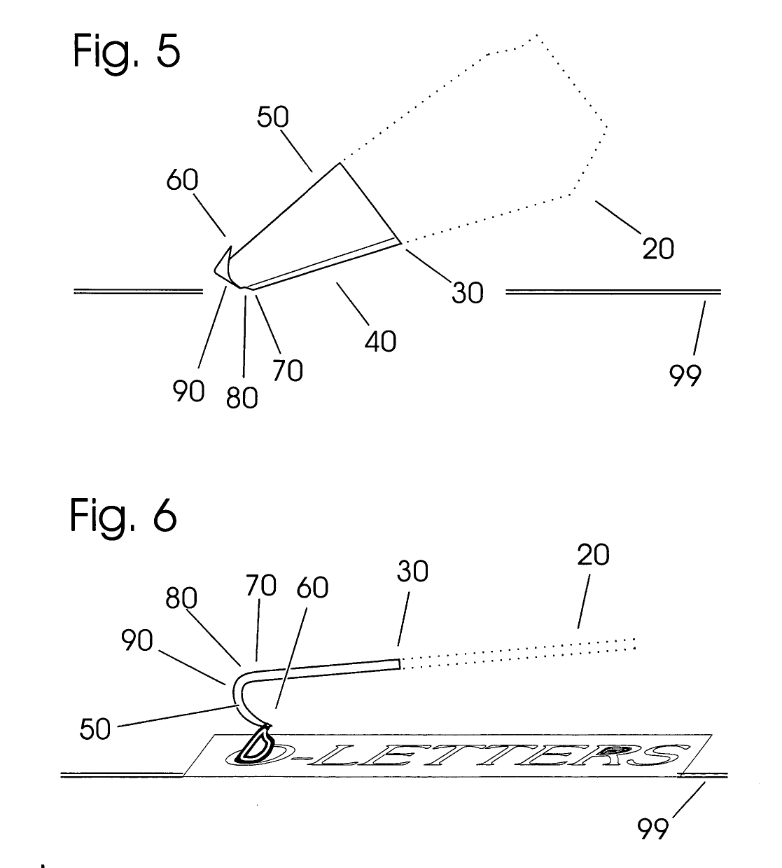

Once oriented, a tool held safety blade is pulled by a user's hand for cutting around an area of vinyl material 99 to be weeded from it's carrier sheet. When cutting, said original cutting edge tip 60 of said hook 90 is positioned laterally to one side of said blade end area 30, and with said point 60 angled slightly and approximately vertically upwards and away from said vinyl lettering material 99, FIG. 5. When cutting is completed, said hand held blade holding tool is slightly rotated within a user's fingers until said hook is in position to pierce said vinyl material 99, FIG. 6. As a user pulls said hook, it piercingly pricks and picks up said unwanted areas of vinyl material 99.

Said pulling action of piercing and picking out said unwanted areas greatly reduces the amount of different muscles of a user's hand required to achieve a simple picking away of one small dot of thousands within said material 99. A user normally would grip any other awl-like tool tighter as they pierce and lift vertically upwards and in a direction away from their body. Said directional movements are opposite from a cutting and or pulling motion. Said hook of said safety blade permits a pulling motion for both picking and cutting functions.

Said opposite directional movements in said picking action may not impact a user who hasn't experienced any type of repeated movements over and over on a daily basis within their workplace.

Yet, any user who has ever experienced carpal tunnel from a same and repeated motion thousands of times in a day, will recognize the importance of said pulling action versus said opposite motions now used, and wherein said motions are used only because of the few tools available within the marketplace to do the job.

When picking said excess material, a user's other hand will easily remove any hooked material, as said hook has no extra barb projections within its hooked shape. A user may also prick and pick numerous and multiple unwanted pieces of material before removing from said hook. A user may then rotate their blade retaining tool holder for fast orientation of said new cutting edge tip without any need for stopping to reach for, and then reorienting another and separate cutting tool.

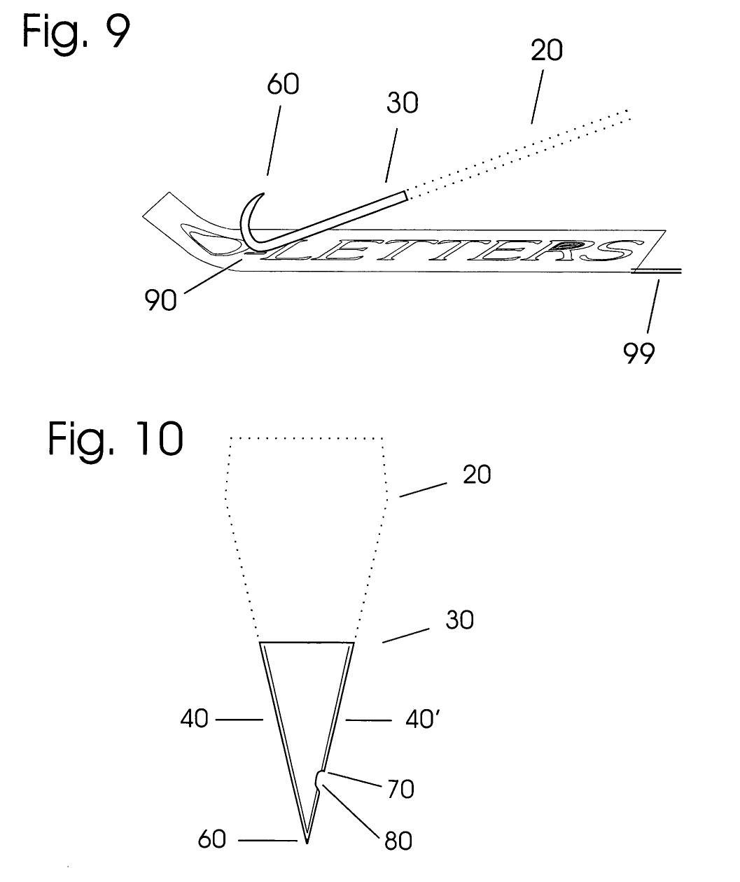

When weeding vinyl material, at least one hand of a user is usually holding said material down and against their worktable while another hand is pulling material away from its carrier. Small and wanted areas within a line of lettering invariably pull away from their carrier sheet accidentally. A user normally reaches for a pair of tweezers, or a sharp pointed blade, or a blunt end stylus to hold down these extremely small lettering parts. Many accidental piercings of wanted areas of lettering occur with each attempt in holding these areas in place. Said round ended portion of said hook shape 90, FIG. 9 will function to hold said areas without piercing said material 99, and with nominal rotation required for orientation of said tool held cutting pick safety blade. With said safety blade retaining tool in hand, a user may cut, or pick up unwanted areas, or hold down any wanted areas of vinyl material 99, and all without laying any tool down to search for another.

Today's sign market of home based vinyl shops expose children and visitors to its related weeding tools. A user will find a cutting pick safety blade much safer than any of the standard and exposed cutting blades or picking awls or long sharp picking tweezers that are now used in the industry. Any accidental piercing of a user's body is restricted by said rounded end of said hook, and if a piercing does occur, it is normally limited in depth by said hook's small size and/or round bend.

A user now has access to greater speed in their work, increased safety within their workplace, and more preventive safety against carpal tunnel hand disorders.

In addition, a manufacturer may easily incorporate and merge this blade end area 30 into most any of their previously chosen blade shank designs or shapes 20.

### FIGS. 2 Thru 9

In the drawings, dotted lines represent a portion of a blade shank of any shape 20, which is unrelated to this invention which particularly relates to a blade's end area 30, and with dotted lines shown only for more complete and understandable drawings.

Further details concerning the drawings comprise;

FIG. 2 as it shows a side view of a blade end area 30 after a notch 80 is placed within said blade end area's elongate cutting edge 40, and prior to a forming of a rounded safety bend of a hook shape. Note how a second, or new cutting edge tip 70 is now exposed, yet mostly inaccessible to cut or slit a planar material's surface, before any picking hook has been bendingly formed.

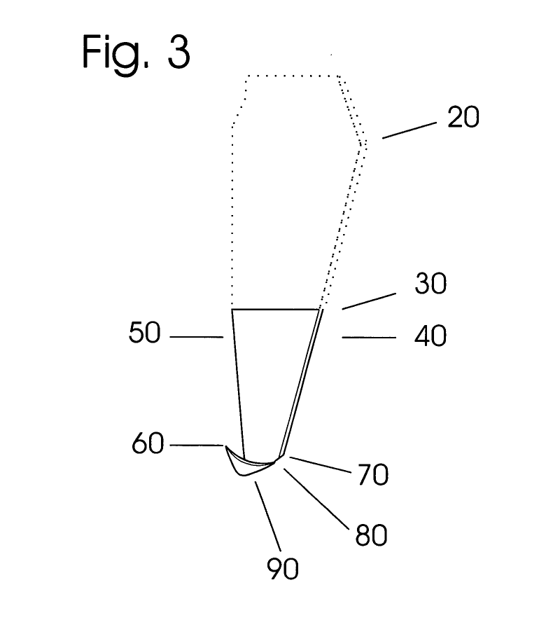

FIG. 3 is a side view of a preferred embodiment as in figure one, and with a slight rotation of said elongate cutting edge 40, and in a direction towards a viewer. Any thickness of shown blade is approximated. Note an angle of an original cutting edge tip 60, and where it directionally points toward a non-cutting flat edge 50. Said angle provides easier access for a blade's tool held hook picking position, and additional clearance for said new cutting edge tip 70 to slit a planar surface.

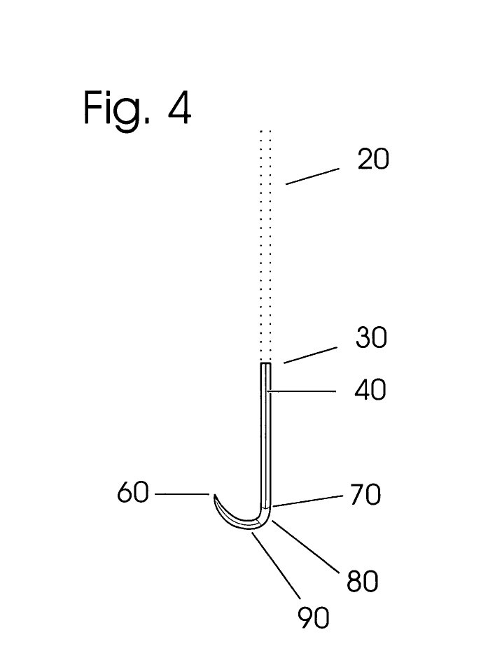

FIG. 4 is a side view of figure three, and shows the blade end area's elongate cutting edge 40. Again, a thickness of the blade is approximated. An angle shown of a rounded safety bend of the hook shape 90 is fairly accurate and may be slightly adjusted by a manufacturer or user to tweak to one's preference for its pickability. Note said notch 80 and said new cutting edge tip 70 within said elongate cutting edge 40. Note how said notch and said bend cooperate to allow further clearance for said new cutting edge tip 70 to abut and cut or slit a planar material's surface.

FIG. 5 is a side view wherein a blade is oriented with its elongate cutting edge 40 positioned to cut or slit an area of vinyl material 99. Note how its hook shape and original cutting edge tip 60 are angled vertically upwards and away from said material 99. Said angled bend allows further clearance for said new cutting edge tip 70 to abut said material's 99 surface for cutting and slitting. Said angled bend also allows further clearance for said original cutting edge tip 60 to extend beyond said blade end area's non-cutting flat edge 50 for a more tolerant degree of angle of a user's hand held blade holding tool. Note that said hook's picking point 60 is available for it's picking action with only an approximate few degrees or so rotational twist of a blade holding tool within a user's hand. Blade holding tool is not shown. A user can cut, pick and hold down material with only a few rotational and or pulling and or holding actions of a blade's tool holder being required.

FIG. 6 shows nearly a same position of a blade as in FIG. 5, but after said blade has been rotated for a hook positioned function. Said blade's flat and non-cutting edge 50 is facing the drawing's viewer. Also shown is an interior and unwanted part of an alphabetical letter O, and after it has been pierced, pricked, or hooked, and as it is being lifted away from said vinyl material's 99 surface. Cutting motions are normally made in areas surrounding shown letters in order to weed out a background of said computer cut vinyl adhesive material 99.

FIG. 7 is a side view as in FIG. 5, but with a curved hook shape shown without the previous angled bend, and where its cutting edge tip is still accessible to a material's surface for cutting, but with less tolerance in its tool held angled position.

FIG. 8 is a side view as in FIG. 5, showing a curved and angled bend, wherein is a more tolerant tool holding position than FIG. 7, and which is due to said angle. Note differences in degree of angles between FIG. 7 and FIG. 8. FIG. 7 lacks an angle in its bend, yet functions fine. FIG. 8 is a preferred embodiment, as it allows a user more choice in an angle or position in which a tool held blade is used.

FIG. 9 is a side view showing said hook's blunt, rounded, and or angled bend holding down wanted material as a user is pulling up unwanted vinyl background, and with said user and any tool blade holder not shown.

### Alternative Embodiment—FIG. 10

Shown in FIG. 10 is an alternative embodiment of a double edged 40, 40′ triangular shaped blade end area 30, and as when a manufacturer chooses a double edged cutting surface blade as their preference. Shown also is a notch placed within one of said cutting edges, and prior to any forming of a hook forming angled bend. In using a double edged triangular shape blade, said second cutting edge surface may make any pricking or piercing of a substrate a little easier by providing a sharper hooked point, yet also doesn't hinder any other of said functions, and yet also isn't required for any of said functions to work well.

### Conclusion, Ramifications, and Scope

Accordingly, the reader will see that the scope of this new cutting, picking, and holding blade goes beyond it's many advantages over many previous blades.

Faster production is achieved through this blade's versatility and with increased and preventive safety features in its use.

Although said previous descriptions contain many specificities, these should not be construed as limiting the scope of the invention but as merely providing illustrations of the presently preferred embodiment of this invention.

Thank you for the chance to apply for this application for patent . . .
Terry Wagenknecht, Sam Wagenknecht, Charles Wagenknecht

What we claim is:

1. In a cutting tool blade end of a type comprising a planar and generally elongate triangular shape cutting blade end area;
whereas said blade end area comprises;
i. a blade end's apex point,
ii. a notch within said blade's elongate cutting edge,
iii. an exposed cutting edge tip located adjacent to said notch,
iv. and a hook forming bend;
whereas said apex point is located at one elongate end of said cutting blade end area;
and whereas said notch is located near said apex point;
and wherein said notch exposes said exposed cutting edge tip;
and whereas an area between said point and said notch, or an area between said point and including said notch is curvedly and or angularly bent;
wherein said bend further exposes said cutting edge tip with sufficient clearance to cut and or slit a planar material's surface;
and wherein a pointed picking hook comprises said apex or said apex and including a portion of said bend;
and wherein said bend's curvatured and or angulared exterior end's bluntness serves as a blade penetration restricting surface;
whereby and as said tool blade is retained within a manufacturer's chosen tool blade holder, the improvement is a cutting tool blade end area comprising a cutting function and or a picking function and or a holding function, wherein a plurality of said functions are accessible with a slight rotation of said tool blade holder.

2. The blade of claim 1 wherein a coloring may be added to one or more planar surfaces to aid a user's recognition of its orientation.

3. The blade of claim 1 wherein said blade is newly formed of metal prior to any potential hardening.

4. The blade of claim 1 wherein said blade is newly formed from a hardened metal.

5. The blade of claim 1 wherein said blade is formed from a previously made blade.

6. The blade of claim 1 wherein said blade is a polymer plastic.

7. The blade of claim 1 wherein an alternative embodiment of said blade is a double edged cutting blade.
